(19) United States
(12) Patent Application Publication
(10) Pub. No.: US 2008/0275578 A1
(43) Pub. Date: Nov. 6, 2008

(54) DATA COLLECTOR CONTROL SYSTEM WITH AUTOMATIC COMMUNICATION PORT SWITCH

(75) Inventors: HONG MING CHANG, TAIPEI CITY (TW); JUI WEN HU, TAIPEI CITY (TW); HUNG WEN CHIOU, HSINCHU CITY (TW)

Correspondence Address: WPAT, PC;INTELLECTUAL PROPERTY ATTORNEYS, 2030 MAIN STREET, SUITE 1300, IRVINE, CA, 92614, US

(73) Assignee: PROMOS TECHNOLOGIES INC., HSINCHU (TW)

(21) Appl. No.: 12/175,865

(22) Filed: Jul. 18, 2008

Related U.S. Application Data
(63) Continuation of application No. 11/433,448, filed on May 15, 2006.

(51) Int. Cl. G05B 9/02

(52) U.S. Cl. 700/79

(57) ABSTRACT

A data collector control system for semiconductor manufacturing comprises a data collector and a automatic communication port switch control circuit. The control system is placed between an equipment and an equipment automation programming (EAP) system. The data collector processes and transmits communication messages between the equipment and the EAP system while the data collector operates normally. The communication messages between the equipment and the EAP system are transmitted through the control circuit instead of the data collector while the data collector operates abnormally.

This application is a continuation application of and claims priority to application Ser. No. 11/433,448, filed May 15, 2006, and the disclosure of which is incorporated by reference.

### BACKGROUND OF THE INVENTION

(A) Field of the Invention

The present invention is related to a data collector control system, and more specifically to a data collector control system with an automatic communication port switch.

(B) Description of the Related Art

FIG. 1 illustrates a schematic diagram of an equipment automation system for semiconductor manufacturing. A data collector 102 is placed between an equipment 101 and an equipment automation programming (EAP) system 103. When the software or hardware of the data collector 102 is out of order, or power of the data collector is unexpectedly shut down, communication between the equipment 101 and the EAP system 103 is interrupted because the data collector 102 cannot switch its transmission path. Therefore, error rates of equipment automation increase, and yield rates of semiconductor products decrease.

### SUMMARY OF THE INVENTION

The objective of the present invention is to provide a data collector control system with an automatic communication port switch, so as to keep signals between an equipment and an equipment automation programming (EAP) system from disconnecting when a data collector is out of order or an unexpected power-off occurs.

The data collector control system of the present invention is placed between the equipment and the EAP system and comprises a data collector and an automatic communication port switch control circuit. The data collector can be an industrial personal computer (IPC) and comprises a main board and a data collector program thereon. The data collector program is used for managing communication messages between the equipment and the EAP system. The automatic communication port switch control circuit comprises a first communication port, a second communication port, an active IC, a passive IC and a switch control circuit. The switch control circuit comprises a half wave rectification circuit, a delay circuit, a first relay and a second relay. The half wave rectification circuit, the delay circuit, the second relay and the first relay connect in order.

The switch control circuit selects the active IC as a transmission path of communication messages between the equipment and the EAP system while the data collector operates normally. The communication messages can be sent from the equipment to the first communication port, then through the active IC to the main board of the data collector and be processed by the data collector program. Subsequently, the communication messages are sent to the EAP system through the second communication port. The communication messages can also be sent from the EAP system to the second communication port, then to the main board of the data collector and be processed by the data collector program. Subsequently, the communication messages are sent to the active IC and then to the equipment through the first communication port.

The switch control circuit selects the passive IC as a transmission path of communication messages between the equipment and the EAP system when the software or hardware of the data collector is out of order. In other words, the transmission path of communication messages between the equipment and the EAP system bypasses the main board of the data collector when the data collector operates abnormally, and this prevents the communication between the equipment and the EAP system from disconnecting.

The automatic communication port switch control circuit further comprises a normal LED indicator, an abnormal LED indicator and a status switch. The status switch comprises a normal position and an abnormal position, which are used for selecting operation modes of the data collector. The communication status between the equipment and the EAP system can be tested by switching the status switch to the abnormal position. When the communication status test is finished, the status switch is moved to the normal position. The normal LED indicator and abnormal LED indicator are used for indicating the status of the data collector control system.

The automatic communication port switch control circuit further comprises a third relay with two switches. When power of the data collector is unexpectedly shut down during normal operation, common points of the two switches are connected from the normal open point to the normal close point simultaneously such that the equipment and the EAP system are connected through the third relay.

### BRIEF DESCRIPTION OF THE DRAWINGS

FIG. 1 illustrates a known schematic diagram of an equipment automation system for semiconductor manufacturing;

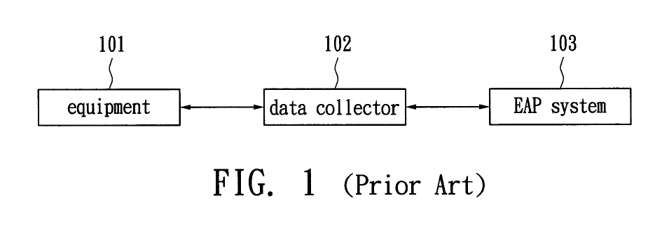

FIG. 2(a) shows a block diagram of a data collector control system with an automatic communication port switch in accordance with one embodiment of the present invention;

FIG. 2(b) shows detail components and circuits regarding the data collector control system of the present invention;

FIG. 2(c) shows detail circuit operations of the first relay and the second relay of the present invention; and

FIG. 2(d) shows a detail circuit operation of the third relay of the present invention.

### DETAILED DESCRIPTION OF THE INVENTION

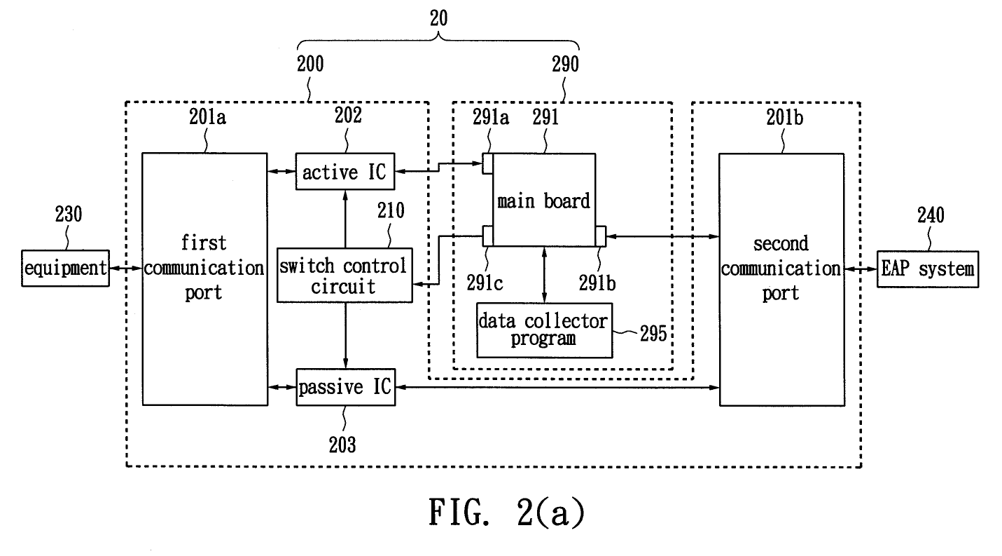

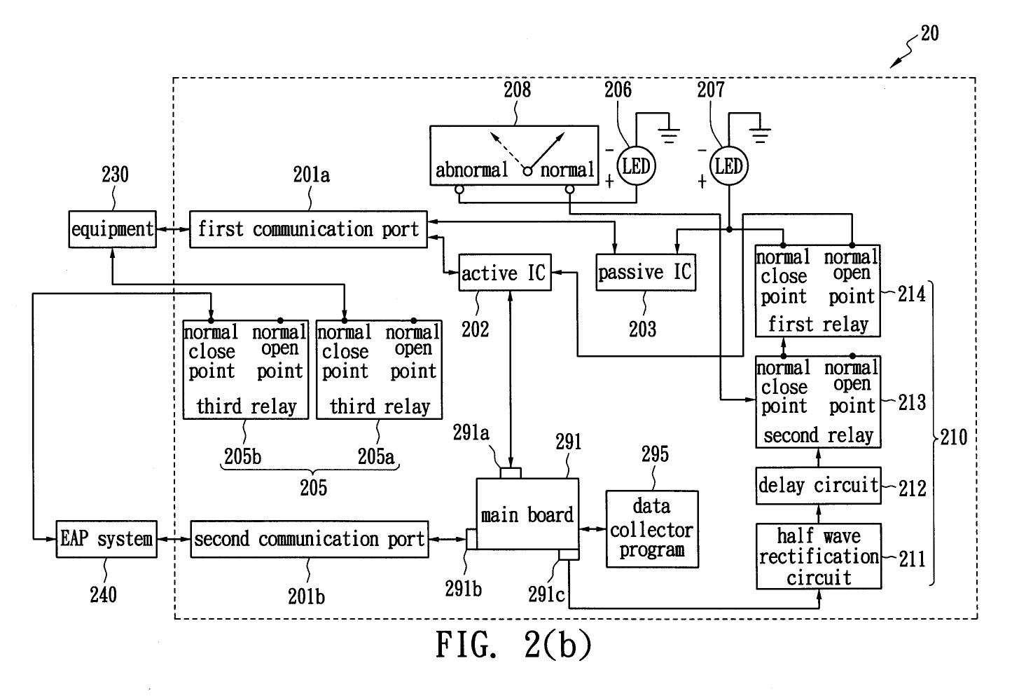

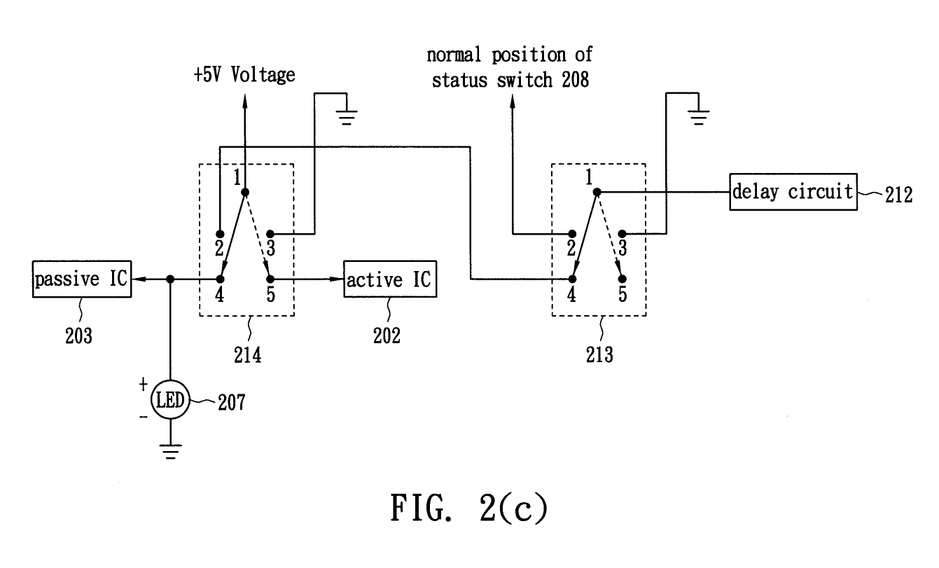

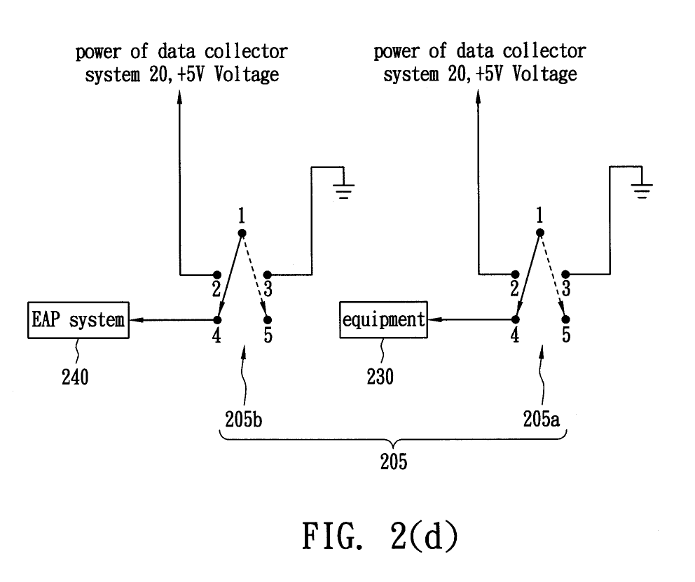

FIG. 2(a) shows a block diagram of a data collector control system 20 with automatic communication port switch in accordance with one embodiment of the present invention. The data collector control system 20 comprises a data collector 290 and an automatic communication port switch automatic communication port switch control circuit 200. The data collector 290 can be an industrial personal computer (IPC) and comprises a main board 291 which can perform a data collector program 295. The data collector program 295 is used for managing communication messages between an equipment 230 and an EAP system 240. The automatic communication port switch control circuit 200 for automatic communication ports switching comprises a first communication port 201a, a second communication port 201b, an active IC 202, a passive IC 203 and a switch control circuit 210. The automatic communication port switch control circuit 200 connects the equipment 230 and the EAP system 240 through the first communication port 201a and the second communication port 201b, respectively. The first communication port 201a and the second communication port 201b are both serial ports.

The main board 291 comprises serial ports 291a, 291b, and 291c. The active IC 202 is placed between the serial port 291a and the first communication port 201a. The serial port 291b connects the second communication port 201b, whereas the serial port 291c connects the switch control circuit 210. All serial ports mentioned above can be implemented by a data interface RS232.

The switch control circuit 210 selects the active IC 202 as a transmission path of communication messages between the equipment 230 and the EAP system 240 when the data collector 290 operates normally. The communication messages can be sent from the equipment 230 to the first communication port 201a, then through the active IC 202 to the main board 291 of the data collector 290. Then the communication messages are processed by the data collector program 295 and subsequently are sent to the EAP system 240 through the second communication port 201b. The communication messages can also be sent from the EAP system 240 to the second communication port 201b, then to the main board 291. Then the communication messages are processed by the data collector program 295 and subsequently are sent to the active IC 202. Then the communication messages are sent to the equipment 230 through the first communication port 201a.

Once the software or hardware of the data collector 290 is out of order, the switch control circuit 210 enables the passive IC 203. The communication messages can be sent from the equipment 230 to the first communication port 201a, then to the passive IC 203. Then the communication messages are sent to the EAP system 240 through the second communication port 201b.

FIG. 2(b) shows detail components and circuits regarding the data collector control system 20. In addition, the automatic communication port switch control circuit 200 further comprises a third relay 205, a normal LED indicator 206, an abnormal LED indicator 207 and a status switch 208. The normal LED indicator 206 and abnormal LED indicator 207 are used for indicating the status of the data collector control system 20. The status switch 208 comprises a normal position and an abnormal position, which are used for selecting operation modes of the data collector 290. The communication status between the equipment 230 and the EAP system 240 can be tested by moving the status switch 208 to the abnormal position. When the communication status test is finished, the status switch 208 is switched to the normal position.

The switch control circuit 210 comprises a half wave rectification circuit 211, a delay circuit 212, a first relay 214 and a second relay 213. The half wave rectification circuit 211, the delay circuit 212, the second relay 213 and the first relay 214 connect in order.

FIG. 2(c) shows detail circuit operations of the first relay 214 and the second relay 213. Each of the first relay 214 and the second relay 213 comprises a switch, two input points 2 and 3, a common point 1, a normal close point 4, a normal open point 5 and an input point 3 connected to ground. The common point 1 of the second relay 213 is connected to the output end of the delay circuit 212, the input point 2 of the second relay 213 is connected to the normal position of the status switch 208. The common point 1 of the first relay 214 is connected to a 5V power supply, the input point 2 of the first relay 214 is connected to the normal close point 4 of the second relay 213. The normal close point 4 of the first relay 214 is connected to the passive IC 203, and the normal open point 5 of the first relay 214 is connected to the active IC 202.

FIG. 2(d) shows a detail circuit operation of the third relay 205. The third relay 205 comprises two switches 205a and 205b. The switches 205a and 205b switch simultaneously such that the equipment 230 and the EAP system 240 are connected through the third relay 205 when power of the data collector system 20 is unexpectedly shut down.

A periodic control signal with −10V to +10V voltage is generated by the data collector program 295 and is outputted from the serial port 291c of the main board 291 to the half wave rectification circuit 211. After the negative voltage has been filtered out by the half wave rectification circuit 211, then delayed by the delay circuit 212, a 10V control signal is generated and inputted to the common point 1 of the second relay 213.

Once the software or hardware of the data collector 290 is out of order, a −10V control signal is generated by the data collector program 295 and is outputted from the serial port 291c of the main board 291 to the half wave rectification circuit 211. After the negative voltage has been filtered out by the half wave rectification circuit 211, then delayed by the delay circuit 212, a 0V control signal is generated and inputted to the common point 1 of the second relay 213.

The anode of the normal LED indicator 206 is connected to the abnormal position of the status switch 208. The normal LED indicator 206 is off when the status switch 208 is in the abnormal position, whereas the normal LED indicator 206 is on when the status switch 208 is in the normal position. The anode of the abnormal LED indicator 207 is connected to the normal close point 4 of the first relay 214, and the status (on or off) of the abnormal LED indicator 207 is determined by the voltage level of the normal close point 4 of the first relay 214.

Operation cases of the data collector control system 20 can be classified in the following 7 cases.

Case 1: In the beginning, the data collector program 295 has not yet started, the status switch 208 is in the abnormal position, the abnormal LED indicator 207 is on and the normal LED indicator 206 is off. After starting and running the data collector program 295 for a period of time, the status switch 208 is switched to the normal position and the normal LED indicator 206 turns on. Simultaneously, the input voltage of the input point 2 of the second relay 213 drops from 5V to 0V, the common point 1 of the second relay 213 is connected to the normal close point 4 such that the input voltage of the input point 2 of the first relay 214 rises from 0V to 10V. Subsequently, the common point 1 of the first relay 214 is connected from the normal close point 4 to the normal open point 5, the abnormal LED indicator 207 turns off and the active IC 202 starts operating.

Case 2: In the beginning, the data collector program 295 has not yet started, the status switch 208 is in the normal position, the common point 1 of the second relay 213 is connected to the normal close point 4, and the abnormal LED indicator 207 and the normal LED indicator 206 are on. After starting and running the data collector program 295 for a period of time, a 10V signal is generated by the delay circuit 212. As the common point 1 of the second relay 213 is connected to the normal close point 4, the input voltage of the input point 2 of the first relay 214 rises from 0V to 10V. Subsequently, the common point 1 of the first relay 214 is connected from the normal close point 4 to the normal open point 5, the abnormal LED indicator 207 turns off and the active IC 202 starts operating.

Case 3: In the beginning, the data collector 290 operates normally, the status switch 208 is in the normal position, the common point 1 of the second relay 213 is connected to the normal close point 4, the abnormal LED indicator 207 is off and the normal LED indicator 206 is on. After the operating system (OS) of the main board 291 or the data collector program 295 crashes, or the hardware of the data collector system 20 is out of order, the output signal of the delay circuit 212 drops from 10V to 0V for a period of time and the input voltage of the input point 2 of the first relay 214 drops from 10V to 0V. Subsequently, the common point 1 of the first relay 214 is connected from the normal open point 5 to the normal close point 4, the abnormal LED indicator 207 turns on and the passive IC 202 starts operating.

Case 4: The status switch 208 is switched from the normal position to the abnormal position to test communication status between the equipment 230 and the EAP system 240 when the data collector 290 operates normally. Then the normal LED indicator 206 turns off immediately and the input voltage of the input point 2 of the second relay 213 rises from 0V to 5V, the common point 1 of the second relay 213 is connected from the normal close point 4 to the normal close point 5 such that the input voltage of the input point 2 of the second relay 214 drops from 10V to 0V. Subsequently, the common point 1 of the first relay 214 is connected from the normal open point 5 to the normal close point 4, and the abnormal LED indicator 207 turns on and the passive IC 203 starts operating.

Case 5: When the power of the data collector system 20 is not yet turned on or is unexpectedly shut down, referring to FIG. 2(d), the common points 1 of the switches 205a and 205b of the third relay 205 are connected to the normal close point 4 simultaneously such that the equipment 230 and the EAP system 240 are connected through the third relay 205.

Case 6: When the power of the data collector system 20 is turned on, the common points 1 of the switches 205a and 205b of the third relay 205 are connected from the normal close point 4 to the normal open point 5 simultaneously so as to break the connection between the equipment 230 and the EAP system 240 through the third relay 205.

Case 7: If the power of the data collector 290 is unexpectedly shut down while the data collector 290 operates normally, then the common points 1 of the switches 205a and 205b of the third relay 205 are connected from the normal open point 5 to the normal close point 4 simultaneously such that the equipment 230 and the EAP system 240 are connected through the third relay 205.

As mentioned above, the switch control circuit 210 selects the passive IC 203 as a transmission path of communication messages between the equipment 230 and the EAP system 240 when the software or hardware of the data collector 290 is out of order, or if power of the data collector is unexpectedly shut down. In other words, the transmission path of communication messages between the equipment 230 and the EAP system 240 bypasses the main board 291 of the data collector 290 when the data collector 290 operates abnormally, and this prevents communication between the equipment 230 and the EAP system 240 from disconnecting.

The above-described embodiments of the present invention are intended to be illustrative only. Numerous alternative embodiments may be devised by those skilled in the art without departing from the scope of the following claims.

What is claimed is:

1. A data collector control system placed between an equipment and an equipment automation programming (EAP) system, comprising:
a data collector configured to manage and transmit communication messages between the equipment and the EAP system when the data collector operates normally; and
an automatic communication port switch control circuit configured to stop the transmission of the communication messages between the equipment and the EAP system through the data collector when the data collector operates abnormally, wherein the communication messages between the equipment and the EAP system are transmitted through the automatic communication port switch control circuit when the data collector operates abnormally.

2. The data collector control system of claim 1, wherein the data collector comprises a main board configured to perform a data collector program, and the data collector program is configured to manage the communication messages between the equipment and the EAP system.

3. The data collector control system of claim 2, wherein the automatic communication port switch control circuit comprises:
a first communication port serving as an interface connected to the equipment;
a second communication port serving as an interface connected to the EAP system; and
a switch control circuit configured to select a transmission path of the communication messages between the equipment and the EAP system based on whether the data collector operates normally or not.

4. The data collector control system of claim 3, wherein the automatic communication port switch control circuit further comprises:
an active IC connected between the data collector and the first communication port and serving as a transmission path of the communication messages between the equipment and the EAP system when the data collector operates normally; and
a passive IC connected between the first communication port and the second communication port and serving as a transmission path of the communication messages between the equipment and the EAP system when the data collector operates abnormally.

5. The data collector control system of claim 3, wherein the first communication port and the second communication port are serial ports.

6. The data collector control system of claim 4, wherein the active IC is placed between the first communication port and a first serial port of the main board, the second communication port is electrically connected to a second serial port of the main board, and the switch control circuit is connected to a third serial port of the main board.

7. The data collector control system of claim 6, wherein a control signal of different voltages is generated by the data collector program according to whether the data collector operates normally or not, and the control signal is transmitted to the switch control circuit through the third serial port for selecting the transmission path of the communication messages between the equipment and the EAP system.

8. The data collector control system of claim 4, wherein the switch control circuit comprises a half wave rectification circuit, a delay circuit, a first switching circuit and a second switching circuit, the half wave rectification circuit, the delay circuit, the second switching circuit and the first switching circuit are connected in sequence, the half wave rectification circuit is connected to the main board, and the first switching circuit is connected to the active IC or the passive IC.

9. The data collector control system of claim 8, wherein the first switching circuit is connected to the active IC if the data collector operates normally, and the first switching circuit is connected to the passive IC if the data collector operates abnormally.

10. The data collector control system of claim 8, wherein the first switching circuit and the second switching circuit are relays.

11. The data collector control system of claim 1, wherein the automatic communication port switch control circuit comprises a relay with two switches, the two switches switch simultaneously when the data collector powers off unexpectedly, thereby the equipment and the EAP system are connected through the relay.

12. The data collector control system of claim 1, wherein the automatic communication port switch control circuit comprises a first LED indicator and a second LED indicator configured to indicate whether the data collector operate normally or not.

13. The data collector control system of claim 12, wherein the first LED indicator turns on when the data collector operates normally, whereas the second LED indicator turns on when the data collector operates abnormally.

14. The data collector control system of claim 8, wherein the automatic communication port switch control circuit further comprises a status switch including a normal position and an abnormal position for manually selecting operation modes of the data collector.

15. The data collector control system of claim 14, wherein the first switching circuit is electrically connected to the passive IC when the status switch switches to the abnormal position.
